(19) United States
(12) Patent Application Publication
(10) Pub. No.: US 2025/0348253 A1
(43) Pub. Date: Nov. 13, 2025

(54) IMAGE FORMING DEVICE, METHOD OF CONTROLLING THE SAME, AND PRINTING SYSTEM

(71) Applicant: SHARP KABUSHIKI KAISHA, Osaka (JP)

(72) Inventor: Michiaki NISHIMURA, Osaka (JP)

(21) Appl. No.: 19/193,028

(22) Filed: Apr. 29, 2025

(30) Foreign Application Priority Data
May 10, 2024 (JP) 2024-076856

(51) Int. Cl. G06F 3/12; G06F 21/31

(52) U.S. Cl. CPC G06F 3/1234; G06F 3/1207; G06F 3/121; G06F 21/31

(57) ABSTRACT

An image forming device includes: a print-job acquirer that acquires a print job to which print data is added; a print-job executor that executes the print job; and a print-job manager that transfers the print data to a transfer destination and deletes the print data when an error occurs during the print job being executed by the print-job executor and that acquires the print data from the transfer destination and causes the print-job executor to re-execute the print job when the error is resolved after the print data is deleted.

### CROSS-REFERENCE TO RELATED APPLICATION

The present application claims priority from Japanese Application No. 2024-076856, filed on May 10, 2024, the contents of which are hereby incorporated by reference into this application.

### FIELD OF THE DISCLOSURE

The present disclosure relates to an image forming device, a method of controlling the image forming device, and a printing system.

### BACKGROUND ART

For example, First Prior Art a printing system including a means that deletes a print job when printing is interrupted during execution of printing of the print job transmitted from an information processing device, and a means that, when interruption of printing is resolved, re-receives, from the information processing device, the print job for which printing has been interrupted earlier. In addition, in the printing system in Conventional Technology1, the information processing device includes a means that transmits, to an image forming device, a suspending request to suspend printing when an error occurs during execution of a print job, on a basis of an operation by a user.

For example, Second Prior Art a technique in which an image management device stores print-receiving information including print data transmitted from a user terminal and a recording data and time of the print data, and when the storage period of the print data exceeds a predetermined storage setting period, the image management device transfers the print data to an image forming device in accordance with the usage state of the user.

In the printing system disclosed in First Prior Art, in a case where an error occurs during the print job being executed and the suspending request is not transmitted from the information processing device to the image forming device on the basis of a user operation, the user needs to perform an operation of re-registering a print job when the occurred error is resolved. In addition, in a case where, by using Second Prior Art, the image management device stores print data transmitted from the user terminal for a predetermined storage setting period, there is a possibility that the storage region of the image management device is more cluttered as the data size of the print data increases. In view of the problem described above, an object of one aspect of the present disclosure is to provide an image forming device, a method of controlling the image forming device, and a printing system that can easily re-execute a print job while temporarily saving print data in a case where printing is interrupted.

### SUMMARY

An image forming device according to an embodiment of the present disclosure includes: a print-job acquirer that acquires a print job to which print data is added; a print-job executor that executes the print job; and a print-job manager that transfers the print data to a transfer destination and deletes the print data when an error occurs during the print job being executed by the print-job executor and that acquires the print data from the transfer destination and causes the print-job executor to re-execute the print job when the error is resolved after the print data is deleted.

A printing system according to an embodiment of the present disclosure includes the image forming device and a management device. The image forming device includes: a print-job acquirer that acquires a print job to which print data is added; a print-job executor that executes the print job; and a print-job manager that transfers the print data to a transfer destination and deletes the print data when an error occurs during the print job being executed by the print-job executor and that acquires the print data from the transfer destination and causes the print-job executor to re-execute the print job when the error is resolved after the print data is deleted. The transfer destination is the management device. The management device includes a storage that stores the print data when the print data is received from the image forming device, and also includes a print-data manager that transmits the print data stored in the storage to the image forming device in response to a request from the image forming device.

A method of controlling an image forming device according to an embodiment of the present disclosure includes: acquiring a print job to which print data is added; executing the print job; transferring the print data to a transfer destination and deleting the print data when an error occurs during the print job being executed; and acquiring the print data from the transfer destination and enabling the print-job executor to re-execute the print job when the error is resolved after the print data is deleted.

### BRIEF DESCRIPTION OF THE DRAWINGS

FIG. 1 is a diagram illustrating one example of an overall configuration of a printing system.

FIG. 2 is a diagram illustrating one example of a print job.

FIG. 3 is a block diagram illustrating one example of a configuration of an image forming device according to a first embodiment.

FIG. 4 is a block diagram illustrating one example of a configuration of a management device according to a second embodiment.

FIG. 5 is a diagram illustrating one example of a print-job management table.

FIG. 6 is a flowchart illustrating one example of an operation of the image forming device according to the first embodiment.

FIG. 7 is a diagram illustrating one example of a delete notification screen.

FIG. 8 is a flowchart illustrating one example of an operation of the image forming device following FIG. 6.

FIG. 9 is a diagram illustrating one example of a re-execution selection screen.

FIG. 10 is a diagram illustrating one example of a re-execution notification screen.

FIG. 11 is a block diagram illustrating one example of a configuration of an image forming device according to a second embodiment.

FIG. 12 is a diagram illustrating one example of a configuration of the management device according to the second embodiment.

FIG. 13 is a flowchart illustrating one example of an operation of the image forming device according to the second embodiment.

FIG. 14 is a flowchart illustrating one example of an operation of the image forming device following FIG. 13.

FIG. 15 is a diagram illustrating one example of an authentication screen.

FIG. 16 is a flowchart illustrating one example of an operation of the image forming device following FIG. 15.

FIG. 17 is a flowchart illustrating one example of an operation of an image forming device according to a third embodiment.

FIG. 18 is a diagram illustrating one example of a transfer selection screen.

FIG. 19 is a flowchart illustrating one example of an operation of a management device according to the third embodiment.

FIG. 20 is a flowchart illustrating one example of an operation of the management device following FIG. 19.

FIG. 21 is a diagram illustrating one example of a re-execution selection screen.

FIG. 22 is a diagram illustrating one example of a delete notification screen.

### DESCRIPTION OF EMBODIMENTS

### First Embodiment

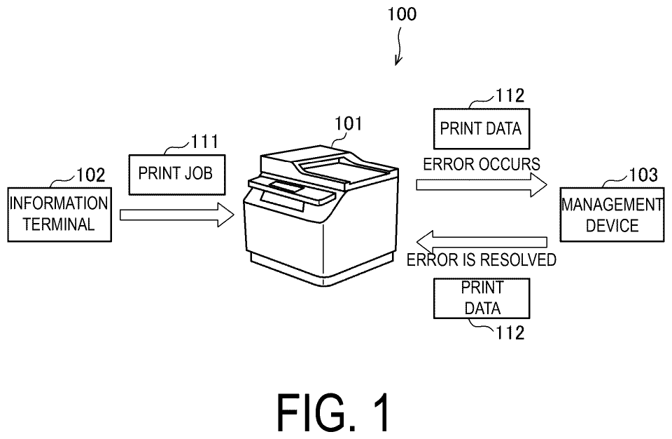

A first embodiment will be described with reference to FIGS. 1 to 10. In the drawings, the same or equivalent elements are denoted by the same reference signs, and redundant descriptions will be omitted.

FIG. 1 is a diagram illustrating one example of an overall configuration of a printing system 100. The printing system 100 includes an information terminal 101, an image forming device 102, and a management device 103.

The information terminal 101 is communicable with the image forming device 102, and is a terminal device that is operated by a user. The information terminal 101 is connected to the image forming device 102 through a wired or wireless network. Examples of the network between the information terminal 101 and the image forming device 102 include the Internet, a local area network (LAN), and the like. Examples of the information terminal 101 include a smartphone, a laptop personal computer (PC), a tablet terminal, a desktop PC, and the like. The information terminal 101 transmits a print job 111 to the image forming device 102.

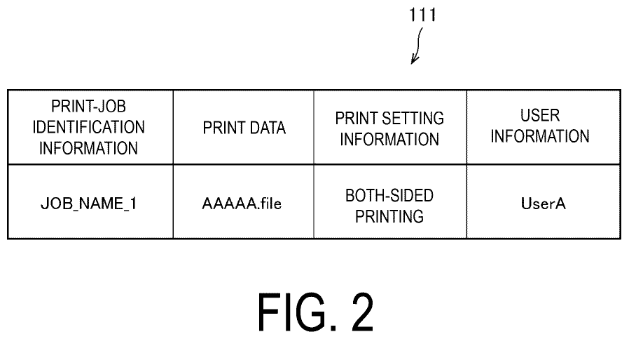

The image forming device 102 executes the print job 111 (see FIG. 2). Specifically, the image forming device 102 executes processing of printing print data 112 added to the print job 111 (see FIG. 2). The image forming device 102 executes processing of printing the print data 112 to form a multi-color or single-color image based on the print data 112 on a sheet.

When an error that interrupts execution of the print job 111 occurs, the image forming device 102 transfers, to the management device 103, the print data 112 added to the print job 111 that has been interrupted. For example, the error indicates occurrence of running out of a sheet and lack of a sheet to be replenished. Alternatively, for example, the error indicates occurrence of paper jam. Then, when the error is resolved, the image forming device 102 acquires the print data 112 from the management device 103, and re-executes the print job 111 to which the print data 112 is added.

The management device 103 is communicable with the image forming device 102, and manages the print data 112 transmitted from the image forming device 102. The management device 103 is connected to the image forming device 102 through a wired or wireless network. Examples of the network between the image forming device 102 and the management device 103 include the Internet, a LAN, and the like.

FIG. 2 is a diagram illustrating one example of the print job 111. Print-job identification information, the print data 112, print setting information, and user information are added to the print job 111 illustrated in FIG. 2 as an example. The print-job identification information includes a character string assigned to the print job, the number, and the like. The print data 112 indicates image data, data in a form of page description language, and the like. The print setting information indicates setting details related to executing printing. For example, the print setting information indicates single-sided printing or both-sided printing or the like. The user information indicates a user name ID of a user that is an owner of the print job 111. For example, the user that is the owner of the print job 111 is a user of the information terminal 101 that serves as the transmission source of the print job 111.

The print job 111 illustrated in FIG. 2 as an example relates to a print job 111 including print-job identification information “JOB_NAME_1”, and the print data 112 is data having a file name “AAAAA.file”. In addition, the print job 111 illustrated in FIG. 2 as an example relates to a print job 111 including print-job identification information “JOB_NAME_1”, and the user that is the owner of this print job 111 is “UserA”.

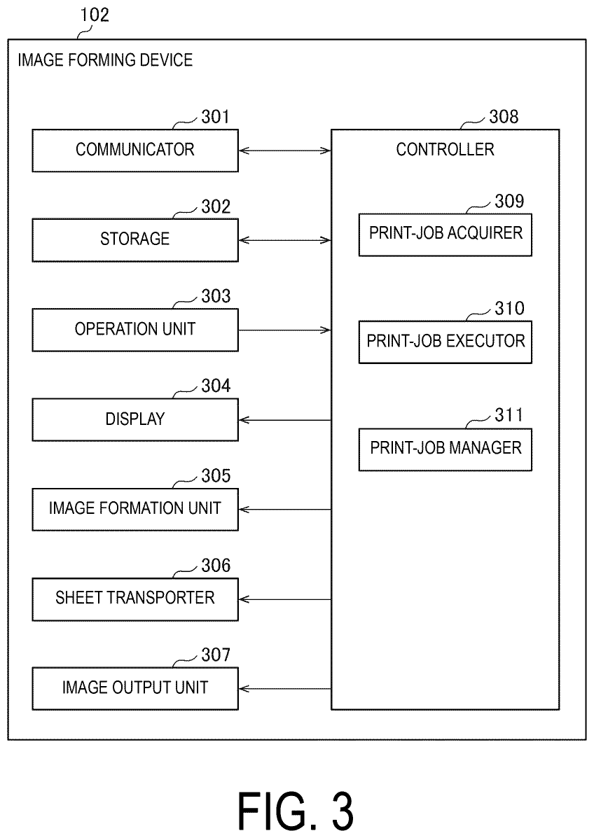

FIG. 3 is a block diagram illustrating one example of the configuration of the image forming device 102. The image forming device 102 includes a communicator 301, a storage 302, an operation unit 303, a display 304, an image formation unit 305, a sheet transporter 306, an Image output unit 307, and a controller 308.

The communicator 301 is an interface connected to the network.

The storage 302 is a storage medium that can store various types of data, programs, and the like. For example, the storage 302 is comprised of a hard disk drive (HDD), a solid state drive (SSD), a semiconductor memory, or the like.

The operation unit 303 receives an operation by a user. For example, the operation unit 303 is comprised of a touch panel, or the like. The display 304 displays information provided to the user. For example, the display 304 is comprised of a liquid crystal panel, an organic electro-luminescence (EL) panel, or the like. Note that a touch panel display in which the operation unit 303 and the display 304 are integrated may be used.

The image formation unit 305 forms, on a sheet, an image based on the print data 112 added to the print job 111. Specifically, the image formation unit 305 adheres a coloring material to a recording medium to form an image based on the print data 112 on a sheet. For example, the image formation unit 305 can be configured as a laser printer employing electrophotographic or an inkjet printer employing an inkjet type. When configured as a laser printer, the image formation unit 305 adheres toner serving as a coloring material to a sheet to form an image on the sheet. In addition, when configured as an inkjet printer, the image formation unit 305 adheres ink serving as a coloring material to a sheet to form an image on the sheet.

The sheet transporter 306 transports the sheet on which an image is formed by the image formation unit 305. The sheet transporter 306 includes a roller used to transport the sheet.

The Image output unit 307 outputs, from a sheet discharging port (not illustrated), the sheet on which the image has been formed by the image formation unit 305.

The controller 308 executes various types of processing in accordance with a program stored in the storage 302. For example, the controller 308 includes a processor such as a central processing unit (CPU). The controller 308 includes a print-job acquirer 309, a print-job executor 310, and a print-job manager 311.

The print-job acquirer 309 acquires the print job 111 to which the print data 112 is added. For example, the print-job acquirer 309 receives the print job 111 transmitted from the information terminal 101 to acquire the print job 111. Alternatively, the print-job acquirer 309 may read a document placed on a document table (not illustrated) to generate the print data 112 indicating the read document. In this case, the print-job acquirer 309 may generate the print job 111 to which the generated print data 112 is added.

The print-job executor 310 executes the print job 111. The print-job executor 310 executes the print job 111 to cause the image formation unit 305 to form, on a sheet, an image based on the print data 112 added to the print job 111, and cause the Image output unit 307 to output the sheet on which the image has been formed.

When an error occurs during the print-job executor 310 executing the print job 111, the print-job manager 311 transfers the print data 112 to a transfer destination, and deletes the print data 112. In addition, when the error is resolved after the print data 112 is deleted, the print-job manager 311 acquires the print data 112 from the transfer destination, and causes the print-job executor 310 to re-execute the print job 111 to which the acquired print data 112 is added. In the printing system 100 according to the present embodiment, the transfer destination of the print data is the management device 103.

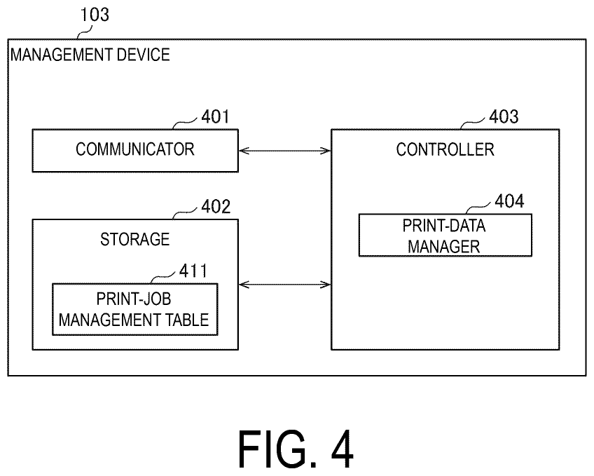

FIG. 4 is a block diagram illustrating one example of a configuration of the management device 103. The management device 103 includes a communicator 401, a storage 402, and a controller 403.

The communicator 401 is an interface connected to the network.

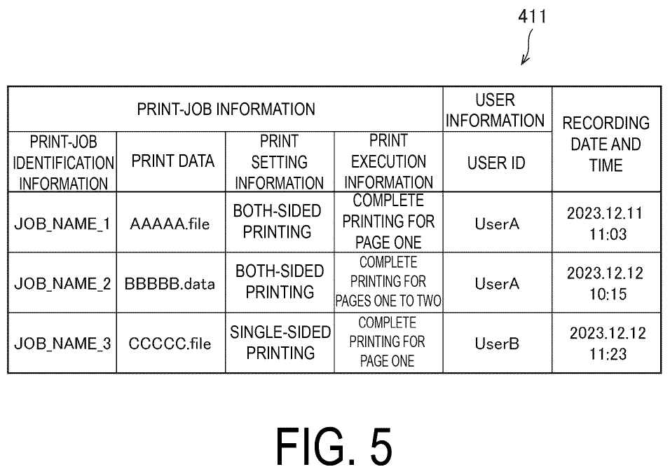

The storage 402 is a storage medium that can store various types of data, programs and the like. For example, the storage 402 is comprised of a HDD, an SSD, a semiconductor memory, or the like. When the communicator 401 receives the print data 112 from the image forming device 102, the storage 402 stores the received print data 112. Specifically, the storage 402 holds a print-job management table 411 (see FIG. 5).

The controller 403 executes various types of processing in accordance with a program stored in the storage 402. For example, the controller 403 includes a processor such as a central processing unit (CPU). The controller 403 includes a print-data manager 404.

The print-data manager 404 transmits the print data 112 stored in the storage 402 to the image forming device 102 in response to a request from the image forming device 102.

FIG. 5 is a diagram illustrating one example of the print-job management table 411. In the print-job management table 411, print-job information, user information, and recording date and time are registered so as to be associated with each other. The print-job information includes print-job identification information, the print data 112, print setting information, and print execution information. The print execution information indicates pages that have been printed until an error occurs and printing is interrupted. The recording date and time indicates date and time when the print-data manager 404 receives the print-job information.

For example, in the print-job management table 411 illustrated in FIG. 5 as an example, the print-job information is associated with user information including a user ID “userA”, and indicates that it is registered at 11:03 on Dec. 11, 2023. The print-job information includes print-job identification information that is “JOB_NAME_1”, the print data 112 that is “AAAAA.file”, print setting information concerning the print job 111 and having print-job identification information that is “JOB_NAME_1”, and print-job execution information concerning the print job 111 and having print-job identification information that is “JOB_NAME_1”.

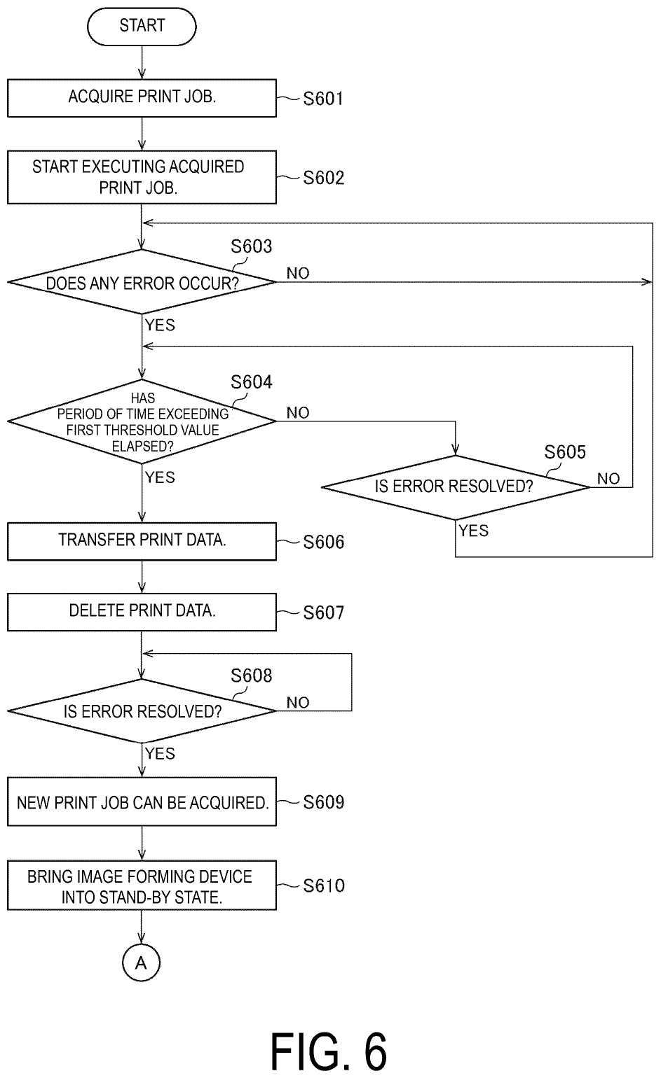

FIG. 6 is a flowchart illustrating one example of an operation of the image forming device 102 according to the present embodiment.

In step S601, the print-job acquirer 309 receives the print job 111 transmitted from the information terminal 101 to acquire the print job 111. The print-job acquirer 309 stores the acquired print job 111 in the storage 302.

In step S602, the print-job executor 310 starts executing the print job 111.

In step S603, the print-job executor 310 determines whether an error occurs during the print job 111 being executed. When an error occurs during the print job 111 being executed, execution of the print job 111 is interrupted. The error indicates occurrence of running out of a sheet and lack of a sheet to be replenished, for example. Alternatively, the error indicates paper jam occurring in the image formation unit 305, the sheet transporter 306, or the Image output unit 307, for example.

In step S603, when no error occurs during the print job 111 being executed, the controller 308 returns the processing to step S603. That is, in step S603, when no error occurs during the print job 111 being executed, the print-job executor 310 continues to cause the image formation unit 305 to execute processing of forming, on the sheet, an image based on the print data 112 added to the print job 111.

In addition, in step S603, when an error occurs during the print job 111 being executed, the print-job executor 310 determines in step S604 whether a period of time exceeding a first threshold value elapses. That is, the print-job executor 310 determines whether a state where execution of the print job 111 is interrupted continues for a period of time exceeding the first threshold value.

When it is determined in step S604 that the period of time exceeding the first threshold value does not elapse from the occurrence of the error, the print-job executor 310 determines in step S605 whether the error is resolved.

When it is determined in step S605 that the error is resolved, the controller 308 returns the processing to step S603. Then, the print-job executor 310 re-executes the print job 111. That is, the print-job executor 310 causes the image formation unit 305 to re-execute the processing of forming, on the sheet, the image based on the print data 112 added to the print job 111. In addition, when it is determined in step S605 that the error is not resolved, the controller 308 returns the processing to step S604.

When it is determined in step S604 that a period of time exceeding the first threshold value elapses, the print-job manager 311 transfers the print data 112 to the management device 103 in step S606.

Specifically, the print-job manager 311 associates the print-job information with the user information to transfer it to the management device 103. The transferred print-job information includes the print-job identification information added to the interrupted print job 111, the print data 112 added to the interrupted print job 111, the print setting information added to the interrupted print job 111, and the print-job execution information concerning the interrupted print job 111. The print-job execution information indicates the number of pages that have been printed before an error occurs and printing is interrupted, for example. The user information associated with the print-job information indicates user information added to the interrupted print job 111. That is, when an error occurs during the time when the print-job executor 310 executes the print job 111, the print-job manager 311 associates the print data 112 with the user information to transfer it to the management device 103.

Then, when the communicator 401 receives the print-job information associated with the user information from the image forming device 102, the print-data manager 404 registered, in the print-job management table 411, the received print-job information, the received user information, and the recording date and time indicating the date and time when the print-job information is received.

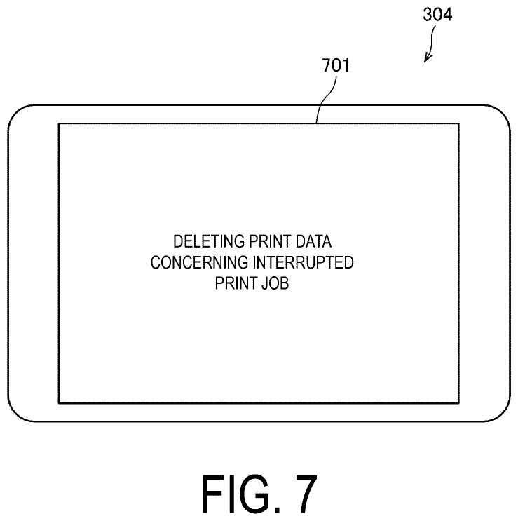

In step S607, the print-job manager 311 deletes, from the storage 302, the print data 112 added to the print job 111 that is interrupted during execution. Then, the print-job manager 311 causes the display 304 to display a delete notification screen 701 (see FIG. 7) that notifies that the print job 111 is being deleted from the storage 302. Then, after the print-job manager 311 transfers the print data 112 to the management device 103 and deletes the print data 112, the print-job executor 310 is able to execute a new print job.

Note that when the print-job information is associated with the user information and is transferred to the management device 103 serving as a transfer destination, the print-job manager 311 may store, in the storage 302, the print-job identification information included in the transmitted print-job information. With this configuration, when an error occurs during the print job 111 being executed, the image forming device 102 according to the present embodiment is able to store, in the storage 302, information used to identify the interrupted print job 111 without cluttering the storage region of the storage 302 due to the print data 112.

Through the processing of step S606 to step S607, after a period of time exceeding the first threshold value elapses from a time when an error occurs during the print job 111 being executed, the print-job manager 311 transfers, to the management device 103, the print data 112 added to the print job 111, and deletes the print data 112. That is, when an error occurs during the print job 111 being executed and the print job 111 is not re-executed after a period of time exceeding the first threshold value elapses, the image forming device 102 according to the present embodiment transfers, to the management device 103, the print data 112 added to the interrupted print job 111 before the print data 112 is deleted from the storage 302. This enables the image forming device 102 according to the present embodiment to save, in the management device 103, the print data 112 added to the interrupted print job 111, and also prevent the storage region of the storage 302 from being cluttered due to the print data 112.

FIG. 7 is a diagram illustrating one example of the delete notification screen 701. For example, the delete notification screen 701 indicates a message “Deleting the print data 112 concerning the interrupted print job”. By causing the display 304 to display the delete notification screen 701, the print-job manager 311 allows a user to recognize that the print data 112 is deleted, the print job 111 for which an error occurs and the job is interrupted ends, and it is possible to accept a new print job.

In subsequent step S608, the print-job executor 310 determines whether the error is resolved. When it is determined in step S608 that the error is not resolved, the controller 308 returns the processing to step S608. Note that when the error is not resolved, the print-job executor 310 does not execute the print job 111. Thus, the print-job acquirer 309 is not able to acquire a new print job. On the other hand, when it is determined in step S608 that the error is resolved, the print-job acquirer 309 is able to acquire a new print job in step S609.

In step S610, the controller 308 brings the image forming device 102 into a stand-by state. As the controller 308 brings the image forming device 102 into the stand-by state, the print-job executor 310 is able to execute a new print job when the print-job acquirer 309 acquires a new print job. Then, the controller 308 moves the processing to step S801.

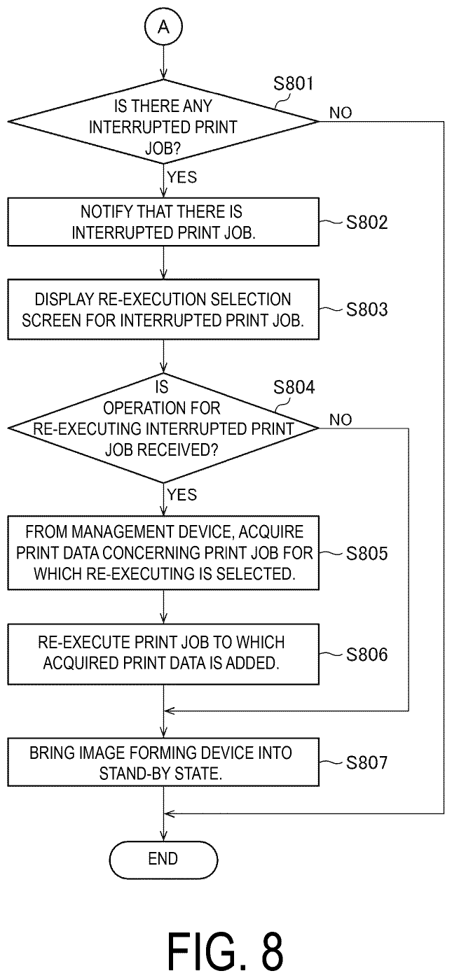

FIG. 8 is a flowchart illustrating one example of an operation of the image forming device 102 following FIG. 6.

In step S801, the print-job manager 311 determines whether there is any print job 111 that is interrupted. For example, the print-job manager 311 inquires of the management device 103 whether the print-job information is registered in the print-job management table 411. The print-data manager 404 notifies the image forming device 102 as to whether the print-job information is registered in the print-job management table 411. When receiving, from the management device 103, a notification indicating that the print-job information is not registered in the print-job management table 411, the print-job manager 311 determines that there is no interrupted print job 111. In addition, when receiving, from the management device 103, a notification indicating that the print-job information is registered in the print-job management table 411, the print-job manager 311 determines that there is an interrupted print job 111. Alternatively, when the print-job identification information included in the transmitted print-job information is stored in the storage 302, the print-job manager 311 determines that there is an interrupted print job 111.

In a case where it is determined in step S801 that there is no print job 111 that is interrupted, when the print data 112 is stored in the management device 103 after the error is resolved, the print-job manager 311 executes, in step S802, processing for notifying that executing the print job 111 is interrupted. For example, the print-job manager 311 causes the display 304 to display a message indicating that there is an interrupted print job 111. Alternatively, the print-job manager 311 may issue an instruction to the information terminal 101 to cause a display (not illustrated) of the information terminal 101 to display a message indicating that there is an interrupted print job 111. Alternatively, the print-job manager 311 causes the display 304 to display print-job identification information concerning the interrupted print job 111.

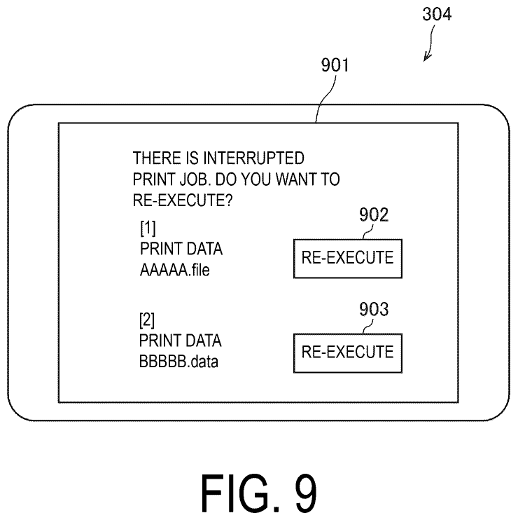

In step S803, the print-job manager 311 displays a re-execution selection screen 901 (see FIG. 9) used to select whether the interrupted print job 111 is re-executed.

In step S804, the print-job manager 311 determines whether the operation unit 303 receives an operation of re-executing the interrupted print job 111. Specifically, the print-job manager 311 determines whether the operation unit 303 receives an operation of re-executing the print job 111 concerning the print-job identification information displayed on the re-execution selection screen 901.

When an operation of re-executing the interrupted print job 111 is not received in step S804, the controller 308 moves the processing to step S807. On the other hand, when the operation of re-executing the interrupted print job 111 is received in step S804, the print-job executor 310 acquires, from the management device 103, the print-job information concerning the print job 111 for which the operation of selecting “re-executing” is received, in step S805. Specifically, the print-job executor 310 transmits, to the management device 103, a transmission request for the print-job information concerning the print job 111 for which the operation of selecting “re-executing” is received. Then, the print-data manager 404 searches the print-job management table 411 for the print-job information for which the transmission request is made, and transmits the print-job information for which the transmission request is made, to the image forming device 102. Then, the print-data manager 404 deletes, from the print-job management table 411, the print-job information transmitted to the image forming device 102. With this configuration, the management device 103 is able to prevent the storage region of the storage 402 from being cluttered due to the print data 112 concerning the print job 111 for which the operation of selecting “re-executing” is received.

In step S806, the print-job manager 311 causes the print-job executor 310 to re-execute the print job 111 to which the print data 112 included in the acquired print-job information is added. Specifically, as for the print data 112 included in the acquired print-job information, the print-job manager 311 causes the print-job executor 310 to start the print job 111 to which the print data 112 included in the acquired print-job information is added, from the page that has been printed and subsequent pages, indicated by the acquired print execution information, on the basis of the acquired print setting information.

Through the processing of step S804 to step S806, when the error is resolved after the print data 112 is deleted and an operation of causing the print-job executor 310 to re-execute the print job 111 is received, the print-job executor 310 causes the print-job executor 310 to re-execute the print job 111. That is, when the error is resolved after the print data 112 is deleted, the image forming device 102 according to the present embodiment is able to re-execute the print job 111 on the basis of the operation by a user. This enables the image forming device 102 according to the present embodiment to delete the print data 112 from the storage 302 when an error occurs during the print job 111 being executed, and to re-execute the print job 111 when the error is resolved.

When the print-job executor 310 completes executing the print job 111 to which the acquired print data 112 is added, the controller 308 brings the image forming device 102 into the stand-by state in step S807. Note that, when an error occurs again during execution of the print job 111 to which the acquired print data 112 is added, the controller 308 returns the processing to step S604 illustrated in FIG. 6 as an example.

FIG. 9 is a diagram illustrating one example of a re-execution selection screen 901. The re-execution selection screen 901 indicates that an error occurs during execution of the print job 111 to which the print data 112 that is “AAAAA.file” is added and execution of the print job 111 to which the print data 112 that is “BBBBB.data” is added. In addition, the re-execution selection screen 901 includes a re-execution button 902 and a re-execution button 903. When an operation of selecting the re-execution button 902 is executed to the operation unit 303 by a user, the print-job manager 311 determines in step S804 illustrated in FIG. 8 as an example that the operation unit 303 receives the operation of re-executing the print job 111 to which the print data 112 that is “AAAAA.file” is added. Furthermore, when an operation of selecting the re-execution button 903 is executed to the operation unit 303 by a user, the print-job manager 311 determines in step S804 that the operation unit 303 receives the operation of re-executing the print job 111 to which the print data 112 that is “BBBBB.data” is added.

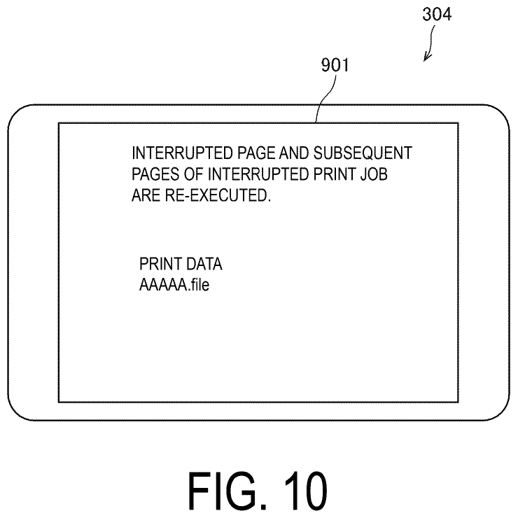

For example, it is assumed that the print-job management table 411 illustrated in FIG. 5 as an example is stored in the storage 302. Then, an operation of selecting the re-execution button 902 is performed to the operation unit 303 by a user. In this case, in step S805 illustrated in FIG. 8 as an example, the print-job executor 310 acquires, from the management device 103, the print data 112 that is “AAAAA.file”, the print setting information, and the print execution information. Then, in step S806 illustrated in FIG. 8 as an example, the print-job executor 310 starts both-sided printing of the print data 112 that is “AAAAA.file” from the second and subsequent pages. In this case, the print-job manager 311 causes the display 304 to display a re-execution notification screen 1001 (see FIG. 10).

FIG. 10 is a diagram illustrating one example of the re-execution notification screen 1001. For example, the re-execution notification screen 1001 indicates a message “Interrupted page and subsequent pages of the interrupted print job are re-executed”. In addition, the re-execution notification screen 1001 indicates characters “AAAAA.file” indicating the print data 112 added to the print job 111 to be re-executed. The image forming device 102 according to the present embodiment causes the display 304 to display the re-execution notification screen 1001, which enables a user to recognize that the interrupted print job 111 is re-executed.

In this manner, when an error occurs during the print job 111 being executed, the image forming device 102 according to the present embodiment transfers the print data 112 added to the print job 111, to the management device 103. With this configuration, when an error occurs during the print job 111 being executed, the image forming device 102 according to the present embodiment is able to prevent the storage region of the storage 302 from being cluttered due to the print data 112 added to the interrupted print job 111.

In addition, when an error occurs during the print job 111 being executed and then, the error is resolved, the image forming device 102 according to the present embodiment acquires the print data 112 from the management device 103 serving as the transfer destination of the print data 112, and re-executes the print job to which the acquired print data 112 is added. With this configuration, when an error occurs during the print job 111 being executed and then, the error is resolved, the image forming device 102 according to the present embodiment is able to re-execute the print job to which the acquired print data 112 is added, without causing a user to perform an operation of re-registering the print job 111. Thus, the image forming device 102 according to the present embodiment is able to temporarily save the print data when printing is interrupted, and to easily re-execute the print job.

### FIRST MODIFIED EXAMPLE

A first modified example of the printing system 100 according to the present embodiment may be configured such that the image forming device 102 determines whether to transfer the print data 112 to a transfer destination, in accordance with a storage available region of the storage 302. For example, the storage available region is indicated by the amount of available memory in the storage 302. Specifically, when an error occurs during the print job 111 being executed and the storage available region of the storage 302 exceeds a threshold value, the print-job manager 311 according to the present modified example does not transfer the print data 112 to the management device 103. In addition, when an error occurs during the print job 111 being executed and the storage available region of the storage 302 is equal to or less than the threshold value, the print-job manager 311 according to the present modified example transfers the print data 112 to the management device 103. With this configuration, when the storage available region of the storage 302 is sufficiently available, the image forming device 102 according to the present modified example does not transfer the print data 112 to the management device 103, whereby suppressing communication between the image forming device 102 and the management device 103.

### SECOND MODIFIED EXAMPLE

A second modified example of the printing system 100 according to the present embodiment may be configured such that the image forming device 102 acquires the print data 112 from the transfer destination when an error is resolved. Specifically, when the error is resolved after the print data 112 is deleted, and the storage 302 is able to hold the print data 112, the print-job manager 311 according to the present modified example may acquire the print data 112 from the management device 103. That is, the print-job manager 311 according to the present modified example stores the print data 112 in the storage 303 before the operation of re-executing the interrupted print job 111 is received. With this configuration, when the operation of re-executing the interrupted print job 111 is received, the image forming device 102 according to the present modified example is able to start re-executing the print job 111 within a short time without acquiring the print data 112 from the management device 103 after this operation is received.

### THIRD MODIFIED EXAMPLE

A third modified example of the printing system 100 according to the present embodiment may be configured such that the transfer destination of the print data 112 is an image forming device differing from the management device 103 and also differing from the image forming device 102. That is, the printing system 100 according to the present modified example may cause a plurality of image forming devices 102 to cooperate with each other without using the management device 103. With this configuration, when an error occurs in the image forming device 102, the printing system 100 according to the present modified example is able to save, to another image forming device, the print data 112 added to the interrupted print job 111.

### Second Embodiment

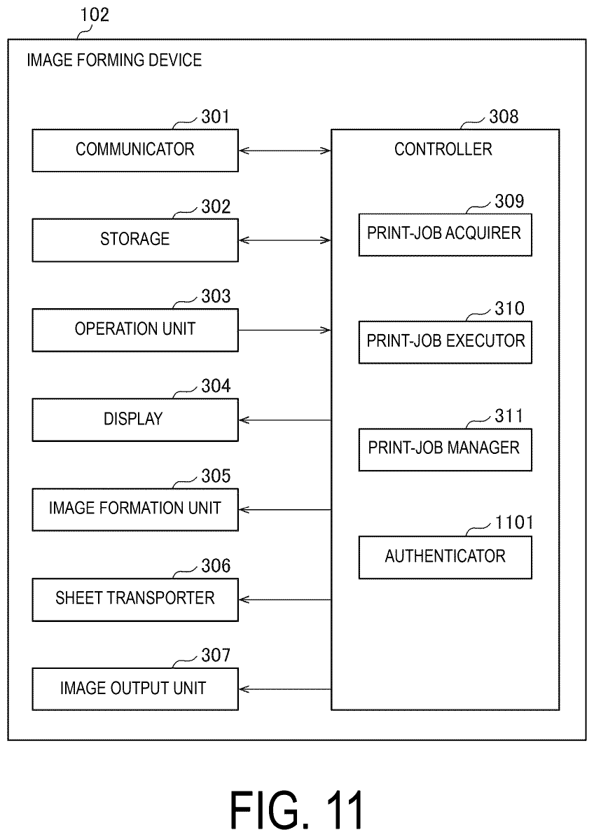

A second embodiment will be described with reference to FIGS. 11 to 16. In the drawings, the same or equivalent elements are denoted by the same reference signs, and redundant descriptions will be omitted. Configurations and processing having substantially the same functions as those in the other embodiments will be referred to by using the same reference characters, descriptions thereof will be omitted, and points differing from the other embodiments will be described.

FIG. 11 is a block diagram illustrating one example of the configuration of the image forming device 102 according to the present embodiment. A difference between the image forming device 102 illustrated in FIG. 11 as an example and the image forming device 102 illustrated in FIG. 3 as an example exists in that the image forming device 102 illustrated in FIG. 11 as an example includes an authenticator 1101.

The authenticator 1101 performs authentication of user information. Specifically, the authenticator 1101 performs authentication of user information designated through an operation received by the operation unit 303. For example, the user information according to the present embodiment indicates a combination of a user ID of a user and a password.

When an error is resolved after deletion of the print data 112 and the authenticator 1101 authenticates the user information, the print-job manager 311 according to the present embodiment acquires, from the management device 103, the print data 112 associated with the authenticated user information, and causes the print job 111 associated with the authenticated user information to be executed.

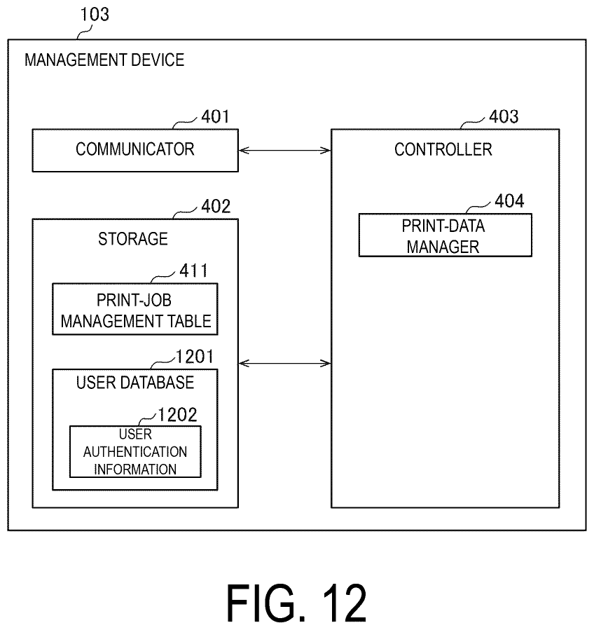

FIG. 12 is a diagram illustrating one example of the configuration of the management device 103 according to the present embodiment. A difference between the configuration of the management device 103 illustrated in FIG. 12 as an example and the configuration of the management device 103 illustrated in FIG. 4 as an example exists in that the management device 103 illustrated in FIG. 12 as an example is configured such that a user database 1201 is included in the storage 302.

User authentication information 1202 is registered in the user database 1201 for each user. The user authentication information 1202 is information used to identify a user. For example, the user authentication information 1202 indicates a combination of a user ID and a password.

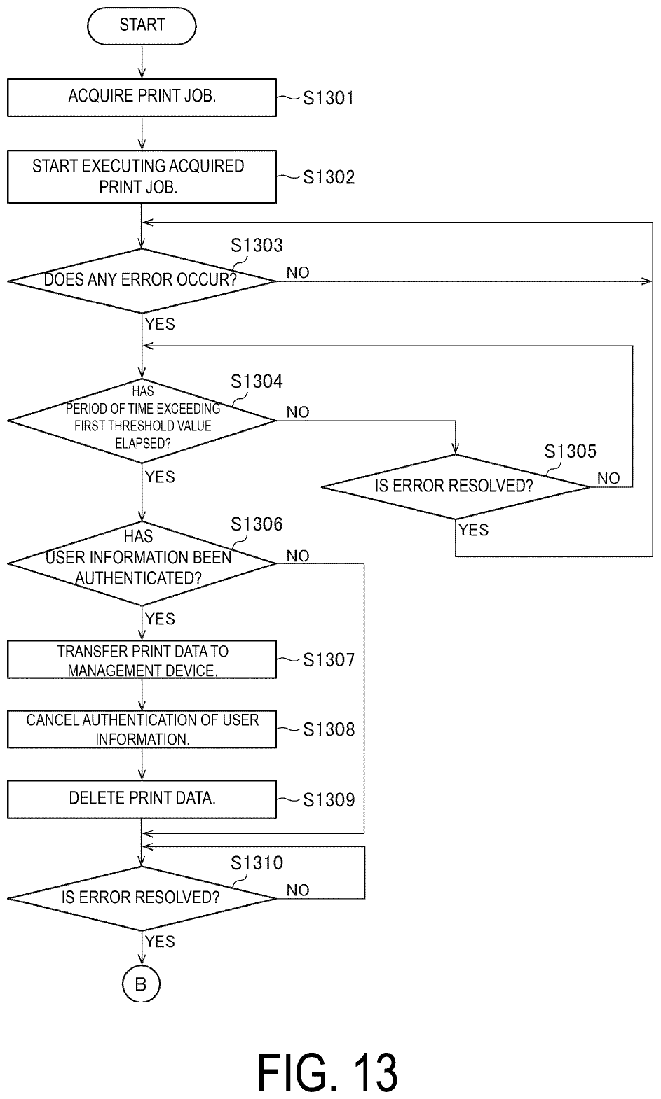

FIG. 13 is a flowchart illustrating one example of an operation of the image forming device 102 according to the present embodiment. Step S1301 to step S1306 are similar to step S601 to step S606 illustrated in FIG. 6 as an example, and hence, detailed explanation thereof will be omitted.

When it is determined in step S1304 that a period of time exceeding the first threshold value elapses, the authenticator 1101 determines in step S1306 whether user information is authenticated. Specifically, when the authenticator 1101 authenticates the user information before the controller 308 executes the processing of step S1301, the authenticator 1101 determines, in step S1306, that the user information is already authenticated. On the other hand, when the authenticator 1101 does not authenticate the user information before the controller 308 executes the processing of step S1301, the authenticator 1101 determines in step S1306 that the user information is not authenticated.

When the user is not authenticated in step S1306, the controller 308 proceeds the processing to step S1310. On the other hand, when the user information is authenticated in step S1306, the controller 308 causes, in step S1307, the print-job manager 311 to transfer the print data 112 to the management device 103. Specifically, the print-job manager 311 associates the user information with the print-job information added to the print job 111 to transmit it to the management device 103. The processing of step S1307 is similar to the processing of step S606 illustrated in FIG. 6 as an example, and hence, detailed explanation thereof will be omitted.

In step S1308, the authenticator 1101 cancels authentication of the user information. By canceling authentication of the user information, the authenticator 1101 determines that the user information is not authenticated.

In step S1309, the print-job manager 311 deletes, from the storage 302, the print job 111 interrupted during execution. The processing of step S1309 is similar to the processing of step S607 illustrated in FIG. 6 as an example, and hence, detailed explanation thereof will be omitted.

In step S1310, the print-job executor 310 determines whether the error is resolved. The processing of step S1310 is similar to the processing of step S608 illustrated in FIG. 6 as an example, and hence, detailed explanation thereof will be omitted.

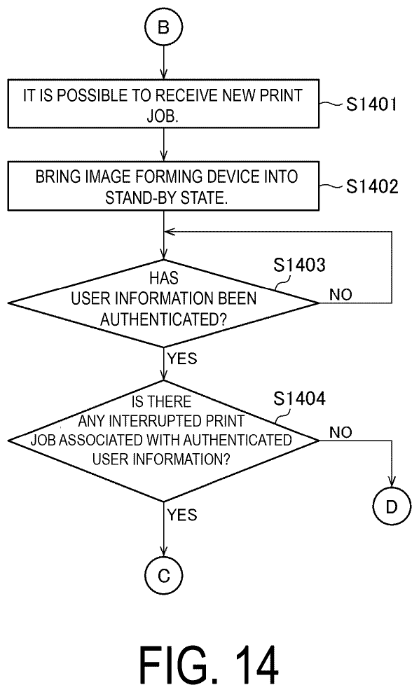

When it is determined in step S1310 that the error is not resolved, the controller 308 returns the processing to step S1310. On the other hand, when it is determined in step S1310 that the error is not resolved, the controller 308 proceeds the processing to step S1401 illustrated in FIG. 14 as an example.

FIG. 14 is a flowchart illustrating one example of an operation of the image forming device 102 following FIG. 13. The processing of step S1401 to step S1402 is similar to the processing of step S609 to step S610 illustrated in FIG. 6 as an example, and hence, detailed explanation thereof will be omitted.

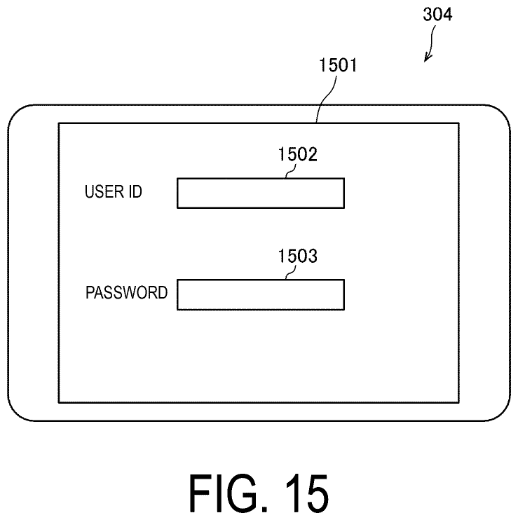

After the controller 308 brings the image forming device 102 into the stand-by state in step S1402, the authenticator 1101 determines, in step S1403, whether authentication is performed to the user information. It is assumed that the user authentication information 1202 indicates a combination of a registered user ID and a registered password, for example. In this case, the authenticator 1101 causes the display 304 to display an authentication screen 1501 (see FIG. 15) used to receive input of a user ID and a password, for example.

FIG. 15 is a diagram illustrating one example of the authentication screen 1501. The authentication screen 1501 includes an input region 1502 used to receive input of a user ID and an input region 1503 used to receive input of a password. The user uses the operation unit 303 to perform an operation of inputting its own user ID registered in the user authentication information 1202, into the input region 1502. In addition, the user uses the operation unit 303 to perform an operation of inputting, into the input region 1503, a password associated with the user ID input into the input region 1502 and registered in the user authentication information 1202. Then, the authenticator 1101 compares the pair of the user ID input into the input region 1502 and the password input into the input region 1503 with a pair of a user ID indicated by the user authentication information 1202 and a password indicated by the user authentication information 1202 to check whether these pairs match each other.

Then, when the pair of the user ID input into the input region 1502 included in the authentication screen 1501 and the password input into the input region 1503 matches the pair of the user ID indicated by the user authentication information 1202 and the user ID indicated by the user authentication information 1202, the authenticator 1101 authenticates the user information indicating the pair of the user ID input into the input region 1502 and the password input into the input region 1503. On the other hand, when the pair of the user ID input into the input region 1502 included in the authentication screen 1501 and the password input into the input region 1503 does not match the pair of the user ID indicated by the user authentication information 1202 and the user ID indicated by the user authentication information 1202, the authenticator 1101 does not authenticate the user information indicating the pair of the user ID input into the input region 1502 and the password input into the input region 1503.

In subsequent step S1403, when the user information is not authenticated, the controller 308 returns the processing to step S1403. On the other hand, when the user information is authenticated in step S1403, the print-job manager 311 determines in step S1404 whether there is any interrupted print job 111. Specifically, the print-job manager 311 determines whether the print-job information associated with the authenticated user information is registered in the print-job management table 411.

For example, the print-job manager 311 inquires of the management device 103 whether the print-job information associated with the authenticated user information is registered in the print-job management table 411. The print-data manager 404 notifies the image forming device 102 as to whether the print-job information associated with the authenticated user information is registered in the print-job management table 411.

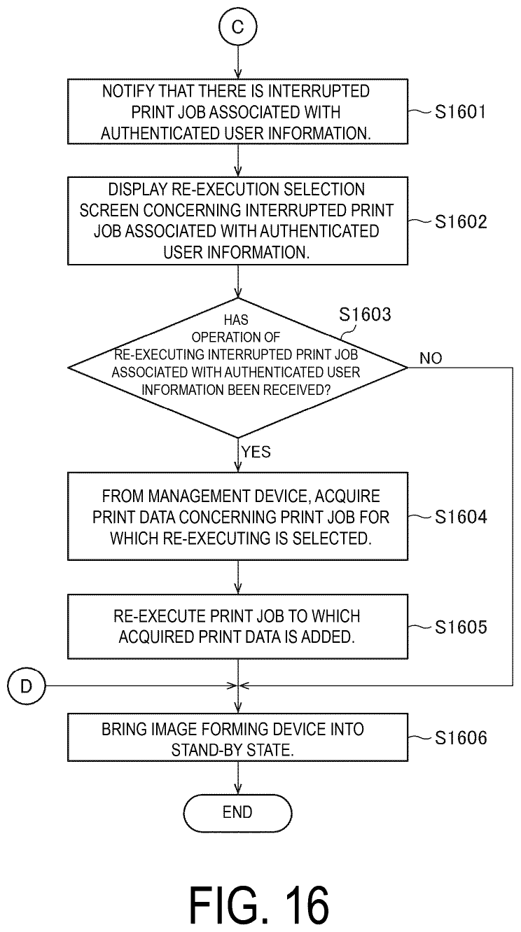

When the print-job information associated with the user information authenticated in step S1404 is not registered in the print-job management table 411, the controller 308 proceeds the processing to step S1606 illustrated in FIG. 16 as an example. On the other hand, when the print-job information associated with the user information authenticated in step S1404 is registered in the print-job management table 411, the controller 308 proceeds the processing to step S1601 illustrated in FIG. 16 as an example.

FIG. 16 is a flowchart illustrating one example of an operation of the image forming device 102 following FIG. 15.

In step S1601, the print-job executor 310 executes processing of giving notification that there is an interrupted print job 111 associated with the authenticated user information. That is, when, after user information is authenticated, executing the print job to which the authenticated user information is added is interrupted and then, an error is resolved, the image forming device 102 according to the present embodiment executes processing for giving notification that there is an interrupted print job 111 associated with the authenticated user information. With this configuration, the image forming device 102 according to the present embodiment is able to prevent the interrupted print job 111 from being re-executed by a third party differing from a user indicated by the authenticated user information.

For example, the print-job manager 311 causes the display 304 to display a message indicating that there is an interrupted print job 111 associated with the authenticated user information. Alternatively, the print-job manager 311 may issue an instruction to the information terminal 101 to cause the display (not illustrated) of the information terminal 101 to display a message indicating that there is an interrupted print job 111 associated with the authenticated user information. Alternatively, the print-job manager 311 causes the display 304 to display the print-job identification information concerning the interrupted print job 111 associated with the authenticated user information.

In step S1602, the print-job executor 310 displays the re-execution selection screen 901 used to select whether to re-execute the interrupted print job 111 associated with the authenticated user information.

In step S1603, the print-job executor 310 determines whether the operation unit 303 receives an operation of re-executing the interrupted print job 111 associated with the authenticated user information. Specifically, the print-job manager 311 determines whether the operation unit 303 receives an operation of re-executing the print job 111 concerning the print-job identification information displayed on the re-execution selection screen 901.

When an operation of re-executing the interrupted print job 111 associated with the user information authenticated in step S1603 is not received, the controller 308 proceeds the processing to step S1606. On the other hand, when an operation of re-executing the interrupted print job 111 authenticated in step S1603 is received, the controller 308 proceeds the processing to step S1604. The processing of step S1604 to step S1606 is similar to the processing of step S805 to step S807 illustrated in FIG. 8 as an example, and hence, detailed explanation thereof will be omitted.

With the configuration described above, the image forming device 102 according to the present embodiment makes it possible to: temporarily save the print data when an error occurs during the print job 111 being executed and printing is interrupted; authenticate the user information when the error is resolved; and re-execute the interrupted print job 111 associated with the authenticated user information.

### Third Embodiment

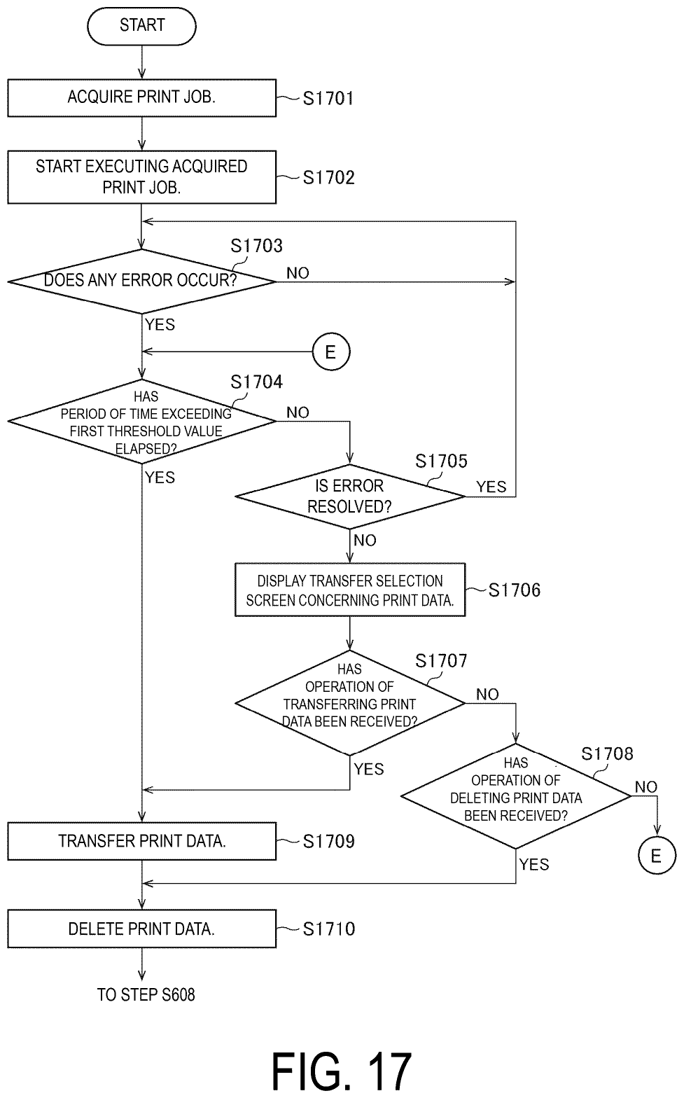

A third embodiment will be described with reference to FIGS. 17 to 22. In the drawings, the same or equivalent elements are denoted by the same reference signs, and redundant descriptions will be omitted. Configurations and processing having substantially the same functions as those in the other embodiments will be referred to by using the same reference characters, descriptions thereof will be omitted, and points differing from the other embodiments will be described.

The configuration of the image forming device 102 according to the present embodiment is similar to the configuration of the image forming device 102 illustrated in FIG. 3 as an example.

When an operation of transferring the print data 112 to the management device 103 is received before a period of time exceeding the first threshold value elapses from a time when an error occurs, the print-job manager 311 according to the present embodiment transfers the print data 112 to the management device 103 before a period of time exceeding the first threshold value elapses from a time when the error occurs.

In addition, when an operation of deleting, in the management device 103, the print data 112 transferred to the management device 103 is received, the print-job executor 310 according to the present embodiment causes the management device 103 to delete the print data 112 transferred to the management device 103.

FIG. 17 is a flowchart illustrating one example of an operation of the image forming device 102 according to the present embodiment. The processing of step S1701 to step S1704 are similar to the processing of step S601 to step S604 illustrated in FIG. 6 as an example, and hence, detailed explanation thereof will be omitted.

When it is determined in step S1704 that a period of time exceeding the first threshold value elapses from a time when an error occurs, the controller 308 proceeds the processing to step S1709. On the other hand, when it is not determined in step S1704 that a period of time exceeding the first threshold value elapses from a time when an error occurs, it is determined in step S1705 whether the error is resolved.

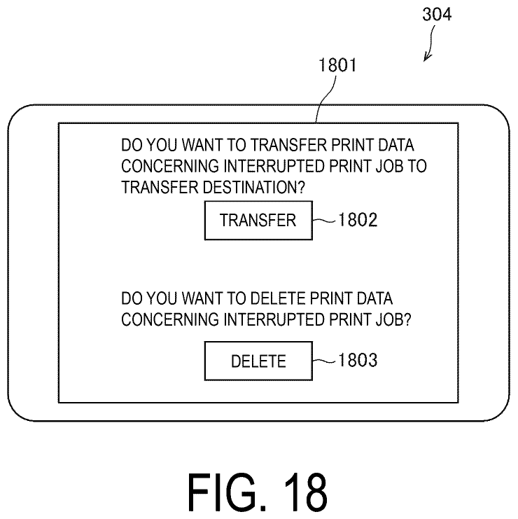

When it is determined in step S1705 that the error is resolved, the controller 308 returns the processing to step S1703. That is, when it is determined in step S1705 that the error is resolved, the print-job executor 310 re-executes the print job 111. On the other hand, when it is determined in step S1705 that the error is not resolved, the print-job manager 311 causes, in step S1706, the display 304 to display a transfer selection screen 1801 (see FIG. 18) used to select whether to transfer the print data 112 concerning the print job 111 that is interrupted during execution, to the management device 103.

In step S1707, the print-job manager 311 determines whether the operation unit 303 receives an operation of selecting transfer of the print data 112 to the management device 103.

When it is determined in step S1707 that the operation unit 303 does not receive the operation of selecting transfer of the print data 112 to the management device 103, the print-job manager 311 determines in step S1708 whether the operation unit 303 receives an operation of selecting deleting the print data 112. When it is determined in step S1708 that the operation unit 303 receives the operation of selecting deleting the printing data 112, the controller 308 proceeds the processing to step S1710. On the other hand, when it is determined in step S1708 that the operation unit 303 does not receive the operation of selecting deleting the printing data 112, the controller 308 returns the processing to step S1704.

When it is determined in step S1707 that the operation unit 303 receives the operation of selecting transfer of the printing data 112 to the management device 103, the controller 308 proceeds the processing to step S1709.

In step S1709, the print-job manager 311 transfers the print data 112 to the management device 103. Specifically, the print-job manager 311 associates the print-job information with the user information to transfer it to the management device 103. The processing of step S1709 is similar to the processing of step S606, and hence, detailed explanation thereof will be omitted. Then, the controller 308 proceeds the processing to step S1710.

Through the processing of step S1706, step S1707, and step S1709, when the operation of transferring the print data 112 to the management device 103 is received before a period of time exceeding the first threshold value elapses from a time when an error occurs, the print-job manager 311 transfers the print data 112 to the management device 103 before the period of time exceeding the first threshold value elapses from a time when the error occurs.

In step S1710, the print-job manager 311 deletes, from the storage 302, the print job 111 interrupted due to occurrence of the error. The processing of step S1710 is similar to the processing of step S607 illustrated in FIG. 6 as an example, and hence, detailed explanation thereof will be omitted. Then, the controller 308 proceeds to step S608 illustrated in FIG. 6 as an example.

FIG. 18 is a diagram illustrating one example of the transfer selection screen 1801. The transfer selection screen 1801 includes a transfer button 1802 and a delete button 1803. When an operation of selecting the transfer button 1802 is performed to the operation unit 303 by a user, the print-job manager 311 determines in step S1707 illustrated in FIG. 17 as an example that the operation unit 303 receives the operation of selecting transfer of the print data 112 to the management device 103. In this case, in step S1709 illustrated in FIG. 17 as an example, the print-job manager 311 transmits the print data 112 to the management device 103 before a period of time exceeding the first threshold value elapses from a time when an error occurs.

In addition, when an operation of selecting the delete button 1803 is performed to the operation unit 303 by a user, the print-job manager 311 determines in step S1707 that the operation unit 303 transmits the operation of selecting deleting the print data 112 to the management device 103. In this case, in step S1710 illustrated in FIG. 17 as an example, the print-job manager 311 deletes, from the storage 302, the print job 111 interrupted due to occurrence of an error, without transmitting the print data 112 to the management device 103. With this configuration, when an error occurs during the print job 111 being executed, the printing system 100 according to the present embodiment enables the image forming device 102 to prevent the print data 112 for which a user does not wish to re-print, from being transmitted to the management device 103. Thus, when an error occurs during the print job 111 being executed, the printing system 100 according to the present embodiment is able to prevent the storage region of the storage 302 from being cluttered due to the print data 112, and also prevent the unnecessary print data 112 from being registered in the print-job management table 411.

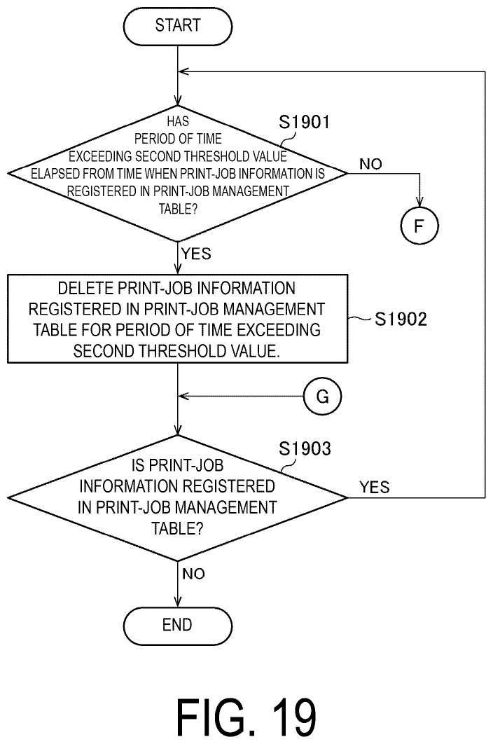

FIG. 19 is a flowchart illustrating one example of an operation of the management device 103 according to the present embodiment. It is assumed that, at a point in time when the controller 403 executes step S1901, the print-job information, the user information, and the recording date and time are registered in the print-job management table 411 so as to be associated with each other.

In step S1901, the print-data manager 404 determines whether a period of time exceeding a second threshold value elapses from a time when the print-job information is registered in the print-job management table 411. Specifically, the print-data manager 404 determines whether print-job information in which a period of time exceeding the second threshold value elapses from the recording date and time registered in the print-job management table 411 is registered in the print-job management table 411.

When the print-job management table 411 includes the print-job information in which a period of time exceeding the second threshold value elapses from the recording date and time registered in the print-job management table 411, the print-data manager 404 determines that the period of time exceeding the second threshold value elapses from a time when the print-job information is registered in the print-job management table 411. On the other hand, when the print-job management table 411 does not include the print-job information in which a period of time exceeding the second threshold value elapses from the recording date and time registered in the print-job management table 411, the print-data manager 404 determines that the period of time exceeding the second threshold value does not elapse from a time when the print-job information is registered in the print-job management table 411.

When it is determined in step S1901 that a period of time exceeding the second threshold value elapses from a time when the print-job information is registered in the print-job management table 411, the print-data manager 404 deletes, in step S1902, the print-job information registered for a period of time exceeding the second threshold value from a time when this information is registered in the print-job management table. That is, when the storage 402 holds the print data 112 for a period of time exceeding the second threshold value, the print-data manager 404 deletes the print data 112 from the storage 402. With this configuration, when the image forming device 102 does not re-execute the interrupted print job after the print data 112 added to the interrupted print job is transferred, the image forming device 102 according to the present embodiment is able to prevent the storage region of the storage 402 of the management device 103 from being cluttered due to the transferred print data 112. Then, the controller 403 proceeds the processing to step S1903.

In step S1903, the print-data manager 404 determines whether the print-job information is registered in the print-job management table 411. When it is determined in step S1903 that the print-job information is registered in the print-job management table 411, the controller 403 returns the processing to step S1901. On the other hand, when it is determined in step S1903 that the print-job information is not registered in the print-job management table 411, the controller 403 ends the processing.

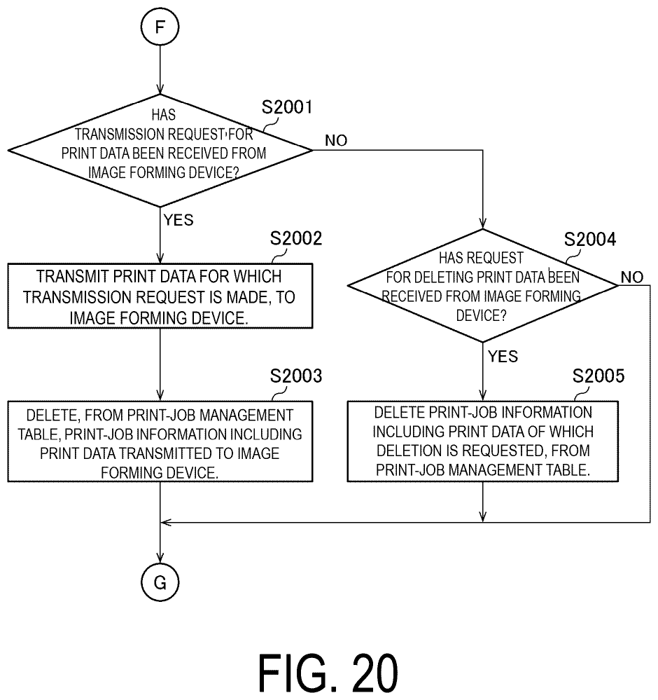

In addition, when it is determined in step S1901 that a period of time exceeding the second threshold value does not elapse from a time when the print-job information is registered in the print-job management table 411, the controller 403 proceeds to step S2001 illustrated in FIG. 20 as an example.

FIG. 20 is a flowchart illustrating one example of an operation of the management device 103 following FIG. 19.

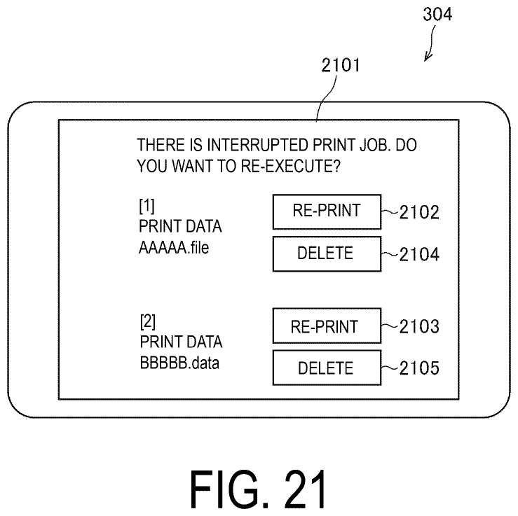

In step S2001, the print-data manager 404 determines whether a transmission request for the print-job information transmitted from the image forming device 102 is received. For example, the print-job manager 311 displays a re-execution selection screen 2101 (see FIG. 21) for selecting re-executing or deleting the interrupted print job 111. When the operation unit 303 receives an operation of selecting re-executing the interrupted print job 111, the print-job manager 311 transmits, to the management device 103, a transmission request for the print-job information concerning the print job 111 for which the operation of selecting re-executing is received.

When the transmission request for the print data 112 is received in step S2001, the print-data manager 404 transmits, to the image forming device 102, the print-job information including the print data 112 for which the transmission request is made, in step S2002.

In step S2003, the print-data manager 404 deletes, from the print-job management table 411, the print-job information transmitted to the image forming device 102. Then, the controller 403 proceeds the processing to step S1903 illustrated in FIG. 19 as an example.

Through the processing of step S2001 to step S2003, the print-data manager 404 is able to delete, from the print-job management table 411, the print-job information transmitted to the image forming device 102 before a period of time exceeding the second threshold value elapses from a time when the print-job information is registered in the print-job management table 411. This configuration enables the management device 103 according to the present embodiment to reduce a period of time for storing the print data 112 in the storage 402.

On the other hand, when the transmission request for the print data 112 is received in step S2001, the print-data manager 404 determines, in step S2004, whether a request for deleting the print data 112 transmitted from the image forming device 102 is received. For example, when the operation unit 303 receives the operation of selecting deleting the print data 112 added to the interrupted print job 111, as for the print data 112 added to the interrupted print job 111, the print-job manager 311 transmits, to the management device 103, a request for deleting the print data 112.

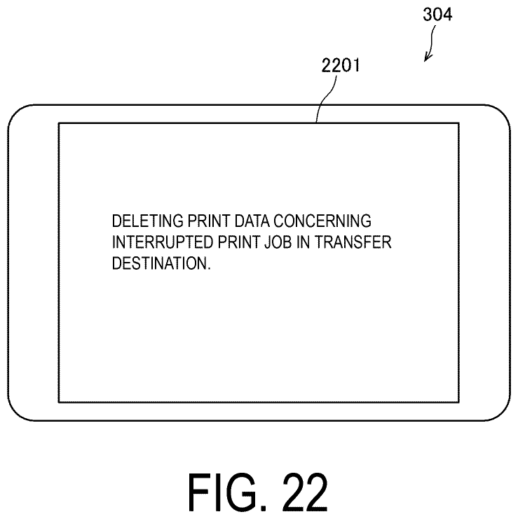

When a request for deleting the print data 112 is received in step S2004, the print-data manager 404 deletes, from the print-job management table 411, the print-job information including the print data 112 requested to be deleted, in step S2005. Then, the print-data manager 404 notifies the image forming device 102 that the print data 112 requested to be deleted is deleted. When the print-job manager 311 receives, from the management device 103, a notification indicating that the print data 112 of which deletion is requested is deleted, the print-job manager 311 causes the display 304 to display the delete notification screen 2201 (see FIG. 22).

When the operation of deleting the print data 112 that has been transferred to the management device 103 is received in the management device 103, the print-job executor 310 causes the management device 103 to delete the print data 112 transferred to the management device 103, through the processing of step S2005. With this configuration, when an operation of deleting the interrupted print job is received after the print data 112 added to the interrupted pint job is transferred, the image forming device 102 according to the present embodiment causes the management device 103 to delete the transferred print data 112, thereby being able to prevent the storage region of the storage 402 of the management device 103 from being cluttered.

On the other hand, when the print-data manager 404 does not receive a request for deleting the print-job information in step S2004, the controller 403 proceeds the processing to step S1903 illustrated in FIG. 19 as an example.

FIG. 21 is a diagram illustrating one example of the re-execution selection screen 2101. The re-execution selection screen 2101 indicates that an error occurs during execution of the print job 111 to which the print data 112 (AAAAA.file) is added and the print job 111 to which the print data 112 (BBBBB.data) is added. In addition, the re-execution selection screen 2101 includes a re-execution button 2102, a re-execution button 2103, a delete button 2104, and a delete button 2105. The re-execution button 2102 and the re-execution button 2103 are similar to the re-execution button 902 and the re-execution button 903 illustrated in FIG. 9 as an example, and hence, detailed explanation thereof will be omitted.

When an operation of selecting the delete button 2104 is performed to the operation unit 303 by a user, the print-job manager 311 determines that the operation unit 303 receives an operation of deleting the print data 112 that is “AAAAA.file”. In addition, when an operation of selecting the delete button 2104 is performed to the operation unit 303 by a user, the print-job manager 311 determines that the operation unit 303 receives an operation of deleting the print data 112 that is “BBBBB.data”.

For example, it is assumed that the print-job management table 411 illustrated in FIG. 5 as an example is stored in the storage 302. Then, it is assumed that an operation of selecting the delete button 2104 is performed to the operation unit 303 by a user. In this case, in step S2005 illustrated in FIG. 20 as an example, the print-data manager 404 deletes the print data 112 that is “AAAAA.file”, the print setting information, and the print execution information from the print-job management table 411. Then, the print-data manager 404 notifies the image forming device 102 of deletion of the print data 112 requested to be deleted.

FIG. 22 is a diagram illustrating one example of the delete notification screen 2201. For example, the delete notification screen 2201 indicates a message “Deleting the print data 112 concerning the interrupted print job 111 in the transfer destination”. The image forming device 102 according to the present embodiment causes the display 304 to display the delete notification screen 2201, which makes it possible to cause a user to recognize that the print data 112 concerning the interrupted print job 111 is deleted.

With the configuration described above, the image forming device 102 according to the present embodiment makes it possible to: temporarily save the print data when an error occurs during the print job 111 being executed and printing is interrupted; and easily re-execute the pint job on the basis of user's operation when the error is resolved. In addition, the image forming device 102 according to the present embodiment causes the management device 103 to delete the print data 112 on the basis of user's operation, which makes it possible to prevent the storage region of the storage 402 of the management device 103 from being cluttered.

Each of the processing executed in the embodiments described above is not limited to the processing mode exemplified in each of the embodiments. The functional blocks described above may be each achieved by using a logic circuit (hardware) formed in an integrated circuit or the like, or by using software using a CPU. Each processing described in the embodiments described above may be executed by a plurality of computers. For example, the processing executed by the individual functional blocks of the image forming device 102 may be executed such that a portion of the processing is executed by another computer, or may be configured such that all the processing is executed by a plurality of computers in a distributed manner.

The present disclosure is not limited to the embodiments described above, and may be replaced with a configuration that is substantially the same as the configuration illustrated in the embodiments described above, a configuration that achieves the same operations and effects, or a configuration that can achieve the same object. As for the present disclosure, an embodiment obtained by appropriately combining technical means disclosed in the different embodiments is also included in the technical scope of the present disclosure. Furthermore, by combining technical means disclosed in the individual embodiments, it is possible to form a new technical feature.

1. An image forming device comprising:
a print-job acquirer that acquires a print job to which print data is added;
a print-job executor that executes the print job; and
a print-job manager that transfers the print data to a transfer destination and deletes the print data when an error occurs during the print job being executed by the print-job executor and that acquires the print data from the transfer destination and causes the print-job executor to re-execute the print job when the error is resolved after the print data is deleted.

2. The image forming device according to claim 1, wherein
when the print data is stored in the transfer destination after the error is resolved, the print-job manager executes processing of notifying that executing the print job is interrupted.

3. The image forming device according to claim 1, wherein
after the print-job manager transfers the print data to the transfer destination and deletes the print data, a new print job is executable by the print-job executor.

4. The image forming device according to claim 1, wherein
user information is further added to the print job, and
when the error occurs during the print job being executed by the print-job executor, the print-job manager associates the print data with the user information to transfer the print data to the transfer destination.

5. The image forming device according to claim 4, further comprising:
an authenticator that authenticates the user information, wherein
when the error is resolved after the print data is deleted, and the user information is authenticated by the authenticator, the print-job manager acquires print data associated with the user information from the transfer destination, and causes the print job associated with the user information to be executed.

6. The image forming device according to claim 1, wherein
after a period of time exceeding a first threshold value elapses from a time when the error occurs, the print-job manager transfers the print data to the transfer destination, and deletes the print data.

7. The image forming device according to claim 6, wherein
when an operation of transferring the print data to the transfer destination is received before the period of time elapses from a time when the error occurs, the print-job manager transfers the print data to the transfer destination before the period of time elapses from a time when the error occurs.

8. The image forming device according to claim 1, wherein
when the error is resolved after the print data is deleted, and an operation of causing the print-job executor to re-execute the print job is received, the print-job executor re-executes the print job.

9. The image forming device according to claim 1, wherein
when an operation of deleting, in the transfer destination, the print data transferred to the transfer destination is received, the print-job executor causes the transfer destination to delete the print data transferred to the transfer destination.

10. The image forming device according to claim 1, further comprising:
a storage, wherein
when the error is resolved after the print data is deleted, and the print data can be stored in the storage, the print-job manager acquires the print data from the transfer destination.

11. A printing system comprising:
the image forming device according to claim 1; and
a management device communicable with the image forming device, wherein
the transfer destination is the management device, and
the management device includes:
a storage that stores the print data when receiving the print data from the image forming device; and
a print-data manager that transmits the print data stored in the storage to the image forming device in response to a request from the image forming device.

12. The printing system according to claim 11, wherein
when the storage stores the print data for a period of time exceeding a second threshold value, the print-data manager deletes the print data from the storage.

13. A method of controlling an image forming device, the method comprising:
acquiring a print job to which print data is added;
executing the print job;
transferring the print data to a transfer destination and deleting the print data when an error occurs during the print job being executed; and
acquiring the print data from the transfer destination and enabling the print-job executor to re-execute the print job when the error is resolved after the print data is deleted.
